(19) United States
(12) Patent Application Publication
(10) Pub. No.: US 2024/0103948 A1
(43) Pub. Date: Mar. 28, 2024

(54) SYSTEM AND METHOD FOR ML-AIDED ANOMALY DETECTION AND END-TO-END COMPARATIVE ANALYSIS OF THE EXECUTION OF SPARK JOBS WITHIN A CLUSTER

(71) Applicant: Microsoft Technology Licensing, LLC, Redmond, WA (US)

(72) Inventors: Nelson Roberto MANOHAR, Ann Arbor, MI (US); Vidip S ACHARYA, Bothell, WA (US); Fady H WAHBA, Kirkland, WA (US)

(21) Appl. No.: 17/954,094

(22) Filed: Sep. 27, 2022

(51) Int. Cl. G06F 11/07

(52) U.S. Cl. CPC G06F 11/0709; G06F 11/0769; G06F 11/0793

(57) ABSTRACT

Example aspects include techniques for ML-aided anomaly detection and comparative analysis of execution of spark jobs within a cluster. These techniques may include collecting, by a cluster-based analytics platform, log entries generated during execution of a DDPE job using one or more services associated with the cluster-based analytics platform and generating signal information based on the log entries. In addition, the techniques may include determining anomaly information based on the signal information and historic signal information and generating a feature vector based on task information, stage information, and/or input-output information of the distributed data processing engine job. Further, the techniques may include determining similarity information based on the feature vector and the historic signal information, the similarity information identifying previously-executed DDPE jobs having a similarity value with the DDPE job above a predefined threshold and determining inference information based on the anomaly information and the similarity information.

### BACKGROUND

Big Data may refer to large volumes of unstructured or structured data. In many instances, distributed data processing frameworks are used to perform operations on and with Big Data, and extract value from Big Data. Distributed data processing frameworks subdivide large amounts of data into smaller partitions, perform the analysis tasks on all of those smaller tasks in parallel to get partial results, and combine those partial results to get a global result. Often distributed data processing Big Data jobs result in errors, exceptions, and/or suboptimal performance. Further, execution of distributed data processing Big Data jobs result in the creation of millions of records. Accordingly, it may be difficult to determine how to resolve errors and exceptions, and improve job performance merely using records generated during performance of the distributed data processing Big Data job and/or log information generated by a distributed data processing framework or analytics platform associated with the distributed data processing framework.

### SUMMARY

The following presents a simplified summary of one or more implementations of the present disclosure in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations of the present disclosure in a simplified form as a prelude to the more detailed description that is presented later.

In some aspects, the techniques described herein relate to a method including collecting, by a cluster-based analytics platform, log entries generated during execution of a distributed data processing engine (DDPE) job using one or more services associated with the cluster-based analytics platform and generating signal information based on the log entries. In addition, the method may include determining anomaly information based on the signal information and historic signal information and generating a feature vector based on task information, stage information, and/or input-output information of the distributed data processing engine job. Further, the method may include determining similarity information based on the feature vector and the historic signal information, the similarity information identifying previously-executed DDPE jobs having a similarity value with the DDPE job above a predefined threshold and determining inference information based on the anomaly information and the similarity information.

In some aspects, the techniques described herein relate to a non-transitory computer-readable device having instructions thereon that, when executed by at least one computing device, cause the at least one computing device to perform operations including: collecting, by a cluster-based analytics platform, log entries generated during execution of a distributed data processing engine (DDPE) job using one or more services associated with the cluster-based analytics platform and generating signal information based on the log entries. In addition, the operations may include determining anomaly information based on the signal information and historic signal information and generating a feature vector based on task information, stage information, and/or input-output information of the distributed data processing engine job. Further, the operations may include determining similarity information based on the feature vector and the historic signal information, the similarity information identifying previously-executed DDPE jobs having a similarity value with the DDPE job above a predefined threshold and determining inference information based on the anomaly information and the similarity information.

In some aspects, the techniques described herein relate to a system including: a memory storing instructions thereon; and at least one processor coupled with the memory and configured by the instructions to: collect, by a cluster-based analytics platform, log entries generated during execution of a distributed data processing engine (DDPE) job using one or more services associated with the cluster-based analytics platform; generate signal information based on the log entries; determine anomaly information based on the signal information and historic signal information; generate a feature vector based on at least one of task information, stage information, and/or input-output (I/O) information of the distributed data processing engine job; determine similarity information based on the feature vector and the historic signal information, the similarity information identifying one or more previously-executed DDPE jobs having a similarity value with the DDPE job above a predefined threshold; and determine inference information based on the anomaly information and the similarity information.

Additional advantages and novel features relating to implementations of the present disclosure will be set forth in part in the description that follows, and in part will become more apparent to those skilled in the art upon examination of the following or upon learning by practice thereof.

### BRIEF DESCRIPTION OF THE DRAWINGS

The Detailed Description is set forth with reference to the accompanying figures, in which the left-most digit of a reference number identifies the figure in which the reference number first appears. The use of the same reference numbers in the same or different figures indicates similar or identical items or features.

FIG. 1 illustrates an example architecture of a network management system, in accordance with some aspects of the present disclosure.

FIG. 2A is a diagram illustrating an example timeline visualization summary (TVS) presented within a graphical user interface (GUI), in accordance with some aspects of the present disclosure.

FIG. 2B is a diagram illustrating an example text summary table (TST) presented within a GUI, in accordance with some aspects of the present disclosure.

FIG. 2C is a diagram illustrating an example similarity table (ST) presented within a GUI, in accordance with some aspects of the present disclosure.

FIG. 2D is a diagram illustrating example similarity information presented within a GUI, in accordance with some aspects of the present disclosure.

FIG. 2E is a diagram illustrating example comparative error information presented within a GUI, in accordance with some aspects of the present disclosure.

FIG. 3 is a flow diagram illustrating an example method for implementing collection of vendor-agnostic state and configuration information from network devices, in accordance with some aspects of the present disclosure.

FIG. 4 is a block diagram illustrating an example of a hardware implementation for a computing device(s), in accordance with some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes techniques for implementing machine learning (ML)-aided anomaly detection and end-to-end comparative analysis of execution of spark jobs within a cluster. The proliferation of the Internet and vast numbers of network-connected devices has resulted in the generation and storage of data on an unprecedented scale. This has largely precipitated from the widespread adoption of social networking platforms, smartphones, wearable devices, and Internet of Things (IoT) devices. These services and devices have the common characteristic of generating a nearly constant stream of data due to user input, user interactions, or sensor information. This unprecedented generation of data has necessitated new methods for processing and analyzing vast quantities of data. The field of gathering and maintaining such large data sets, including the analysis thereof, is commonly referred to as “Big Data.”

As described above, distributed data processing frameworks are primarily used to perform operations on and with Big Data and extract value from Big Data. Distributed data processing frameworks subdivide large amounts of data into smaller partitions, perform the analysis tasks on all of those smaller partitions in parallel to get partial results, and combine those partial results to get a global result. For example, Apache Spark is an open source cluster computing framework that provides distributed task dispatching, scheduling, and basic functionality. Apache Spark divides a data processing task into a large number of small fragments of work, each of which may be performed on one of a large number of compute nodes.

Further, an analytics platform may provide an end to end environment for executing Apache Spark jobs. For example, Azure Synapse Analytics is an analytics platform that incorporates diverse and critical aspects to a job's workflow such as submission, authorization, access rights, resource allocation, resource monitoring, scale adaptation, credential availability, and storage access. When executing a Spark job within an analytics platform, millions of data records may be created as a result by the Apache Spark engine and other services associated with execution of the Apache Spark job. Accordingly, it may be cumbersome to use the investigative tools of existing analytics platforms to organize the resulting records and identify causes of error or performance delays arising during execution of the Apache Spark job.

Aspects of the present disclosure provide anomaly detection and comparative analysis of Apache Spark job via an analytics platform. In particular, the analytics platform may generate an end-to-end comprehensive ML-aided data analytics report for the events in the lifecycle of the Apache Spark job, and a graphical user interface (GUI) displaying an end-to-end integrated timeline history of the events, exceptions, warnings, errors, and other key lifecycle events (e.g., receiving the job, allocating the resources, executing the job, and deallocating resources). Further, the analytics platform may identify anomalies in extracted error signals from a cluster when compared to representative sampling from other clusters, and other jobs in the same pool exhibiting sufficient similarity. In addition, the analytics platform may employ the anomaly information and similarity information to predict job results, mitigate errors and/or exceptions, and/or improve job performance. Accordingly, the present techniques improve forensics reporting of distributed data processing jobs by increasing the ease of use of analytics platforms and providing ML-based recommendations for mitigating errors/exceptions and improving job performance.

### Illustrative Environment

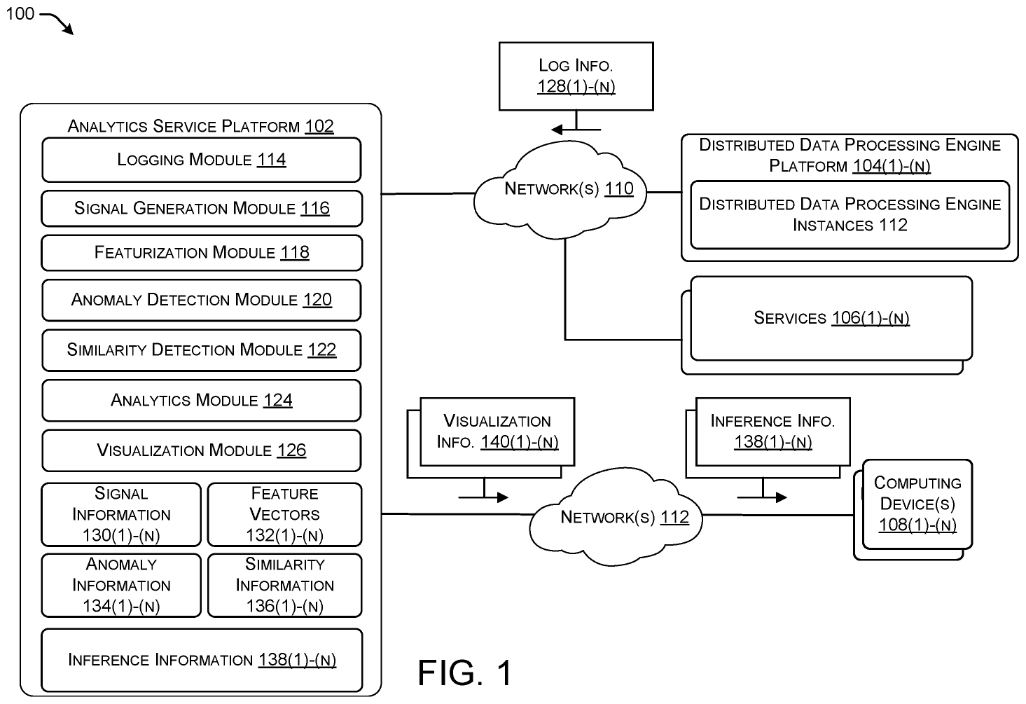

FIG. 1 is a diagram showing an example architecture of a cluster-based analytics platform, in accordance with some aspects of the present disclosure. As illustrated in FIG. 1, the cluster-based analytics platform 100 may include an analytics service platform 102 (e.g., a telemetry analytics platform), a DDPE platform 104 (e.g., a cluster-based DDPE platform), one or more services 106(1)-(n), one or more computing devices 108(1)-(n), and one or more networks 110(1)-(n). The one or more networks 110(1)-(n) may comprise any one or combination of multiple different types of networks, such as cellular networks, wireless networks, local area networks (LANs), wide area networks (WANs), personal area networks (PANs), the Internet, or any other type of network configured to communicate information between computing devices (e.g., the analytics service platform 102, the DDPE platform 104, the one or more services 106(1)-(n), and the one or more computing devices 108(1)-(n). As used herein, in some aspects, “cluster-based” may refer to a platform that utilizes a group of computing machines that are treated as a single device and process the execution of commands in parallel.

In some aspects, the analytics service platform 102 may be a multi-tenant environment that provides the computing devices 108(1)-(n) with distributed storage and access to software, services, files, and/or data via the one or more network(s) 110(1)-(n). In a multi-tenant environment, one or more system resources of the analytics service platform 102 are shared among tenants but individual data associated with each tenant is logically separated. For example, the analytics service platform 102 may be a cloud computing platform, and offer analytics as a service. Further, in some aspects, a computing device 108 may include one or more applications configured to interface with the analytics service platform 102.

The DDPE platform 104 may provide application programming interfaces (API) for executing DDPE jobs which manipulate and query data (e.g., Big Data). In particular, the DDPE platform 104 may provide distributed task dispatching, scheduling, and basic (input/output) I/O functionalities. In some aspects, the DDPE platform 104 may employ a specialized data structured (e.g., a resilient distributed dataset) distributed across a plurality of computing devices of the DDPE platform 104. Further, in some instances, the DDPE platform 104 may run transformation operations (e.g., map, filter, sample, etc.) on the specialized data structure and perform action operations (e.g., reduce, collect, count, etc.) on the specialized data structure that return a value.

As illustrated in FIG. 1, a DDPE platform 104 may include a plurality of DDPE instances 112(1)-(n). The DDPE instances 112(1)-(n) may be instances of a data processing framework (e.g., Apache Spark) each configured to perform DDPE jobs (i.e., Big Data analytic jobs). Within the DDPE instances 112(1)-(n), distributed computations may be divided into jobs, stages, and tasks. As used herein, in some aspects, a job may refer to a sequence of stages triggered by an action. As used herein, in some aspects, a stage may be a set of tasks that can be run in parallel to improve the processing throughput. As used herein, in some aspects, a task may be a single operation applied to a portion of the specialized data structure. In some aspects, the DDPE instances 112 may unify batch processing, interacting structure query language (SQL), real-time processing, machine learning, deep learning, and graph processing to perform DDPE jobs. In some aspects, the DDPE instances 112(1)-(n) may process operations in parallel while storing the target data in-memory using cluster computing to perform DDPE jobs. Further, the DDPE instances 112(1)-(n) may use the one or more services 106(1)-(n) to perform the DDPE jobs. In some aspects, the one or more services 106(1)-(n) may be data sources. Some examples of the one or more services include a hypertext transport protocol (HTTP) frontend which receives batch jobs as computation requests, a notebook for interactive jobs which submits computation requests as HTTP requests, a credential service which performs authorization for the use of components within the system and cluster, storage services which store data as blobs or files, databases (e.g., SQL databases, noSQL databases) which provide querying and storing of data, and a cluster which provides a collection of stitched nodes including a container manager, a naming service, resource allocation, and execution containers.

In some aspects, the analytics service platform 102 may be configured to provide enterprise data warehousing and Big Data analytics to a client via a single service. For example, the analytics service platform 102 may manage store enterprise data, provide access to the enterprise data, manage performance of DDPE jobs over the enterprise data, and provide analysis of the performance of the DDPE jobs. As illustrated in FIG. 1, the analytics service platform 102 may include a logging module 114, a signal generation module 116, a featurization module 118, an anomaly detection module 120, a similarity detection module 122, an analytics module 124, and a visualization module 126.

The logging module 114 may collect log information 128(1)-(n) from the DDPE instances 112(1)-(n) and the one or more services 106(1)-(n) (e.g., telemetry databases). The log information 128(1)-(n) may include debugging information, error information, exception information, status information, job result information, operation status information, task information, stage information, input-output (I/O) information, instantiation information, teardown information, job initiation information, job completion information, request and response history, diagnostic information, telemetry information, service status information, event information, lifecycle events, and/or transaction information generated by the DDPE instances 112(1)-(n) and the one or more services 106(1)-(n) during execution of DDPE jobs by the DDPE instances 112(1)(n).

The signal generation module 116 may generate signal information 130(1)-(n) based on the log information 128(1)-(n). In some aspects, the signal information 130 may be better formatted for use in machine learning operations. As such, the construction of error and performance signal information may be used to provide predictive classification of error attribution, error resolution, related personnel of an error, and error remediation steps. In some aspects, the signal generation module 116(1)-(n) may collate and combine log entries from the log information 128(1)-(n) into signals within the signal information 130(1)-(n). For example, the logging module 114 may provide the logging information 128 received from the DDPE instances 112(1)-(n) and the services 106(1)-(n) during execution of a particular DDPE job to the signal generation module 116, and the signal generation module 116 may generate signal information 130 for the particular DDPE job. In some aspects, the signal information 130 may be concise and easier to read than the log information 128(1)-(n). Further, in some aspects, the signal generation module 116(1)-(n) may employ machine learning and/or pattern recognition techniques to generate the signal information 130(1)-(n) from the log information 128(1)-(n).

The featurization module 118 may generate feature vectors 132(1)-(n) via one or more featurization processes. As described herein, in some aspects, “featurization” may refer to mapping data into a numerical vector. Further, in some aspects, the numerical vector may be formatted for use in one or more ML operations. In some aspects, the featurization module 118 may generate a feature vector 132 for an individual DDPE job executed by one or more DDPE instances 112. Further, the featurization module 118 may generate a feature vector 132 based at least in part on the task information, the stage information, and/or the I/O information of the DDPE job. In addition, in some aspects, the featurization module 118 may generate a feature vector 132 based on the signal information 130(1)-(n) determined for a DDPE job.

The anomaly detection module 120 may determine anomaly information 134 based on the signal information 130(1)-(n). For example, the anomaly detection module 120 may compare the signal information 130 for a DDPE job to other signal information 130 corresponding to previously-executed DDPE jobs. In some aspects, the anomaly detection module 120 may determine anomaly values for individual signals of the signal information 130 of a particular DDPE job. Further, the anomaly detection module 120 may determine that a signal is anomalous if one of the anomaly values is above a predefined threshold. Some examples of featurization are error/warning counts, error/warning term frequencies, error term importance, error message n-grams frequencies, log message error classification and probabilities, log error message anomaly ranking.

The similarity detection module 122 may determine similarity information 136 based on the feature vectors 132(1)-(n). In some examples, the similarity detection module 122 may employ at least one of a clustering distance technique, a cosine similarity technique, and/or a text-based similarity technique to determine similarity values between DDPE jobs using the feature vectors 132 associated with the DDPE jobs. In some examples, the similarity detection module 122 may identify a similarity between two DDPE jobs based on similarity of SQL query plans and underlying physical operators, similarity of stage statistics and underlying task statistics, similarity of application names, and/or similarity of ML-featurization embeddings. Further, the similarity detection module 122 may determine that a DDPE job is a similar to a previously-executed DDPE job based at least in part on a similarity value being greater than predefined value. As such, in some aspects, the feature vector 132 provides a concise representation of the execution behavior of a DDPE job in terms of signal extraction features related to errors, warnings, anomalies, completion progress, anomaly and performance measurements that is used for identification of similarities between DDPE jobs.

The analytics module 124 may generate inference information 138(1)-(n) based at least in part on the anomaly information 134 and/or the similarity information 136. In some aspects, the inference information 138(1)-(n) may include at least one of a likelihood of a predefined job result (e.g., success, failure, timeout), a mitigation strategy for resolving an error and/or exception, and/or a tuning strategy for improving execution of a job (e.g., reducing execution time, the number of errors/exceptions during execution, or the amount of resources consumed during execution). In particular, the analytics module 124 may determine inference information 138(1)-(n) for a particular DDPE job based upon previous actions taken with respect to previously-executed DDPE jobs determined to be similar to the particular DDPE job and/or anomalous signals associated with previously-executed DDPE jobs. Further, the analytics module 124 may employ machine learning and/or pattern recognition techniques to generate the inference information 138(1)-(n), e.g., one or more decision trees.

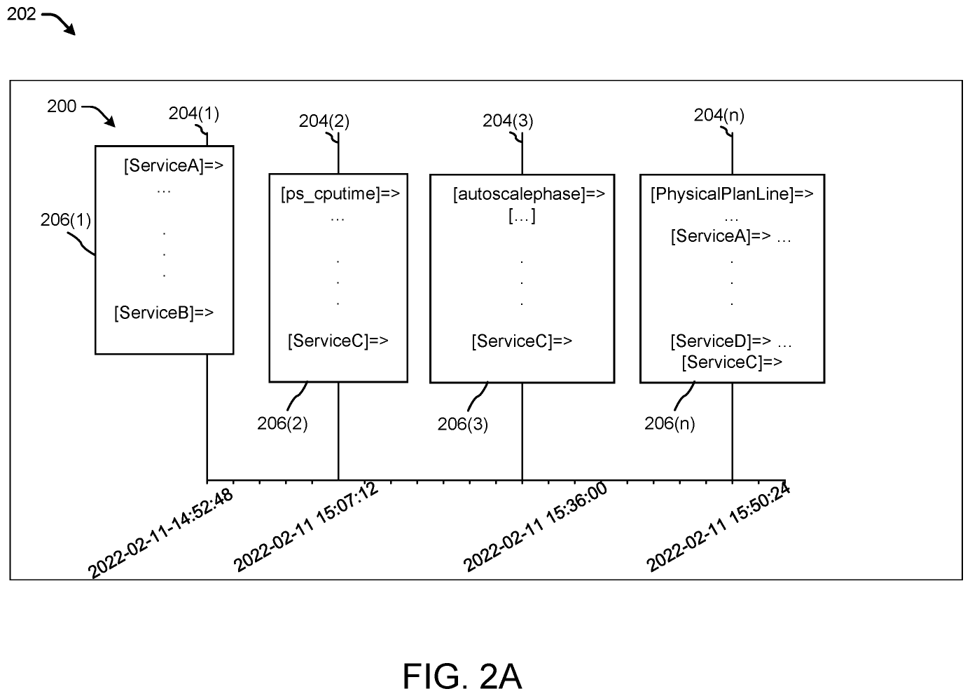

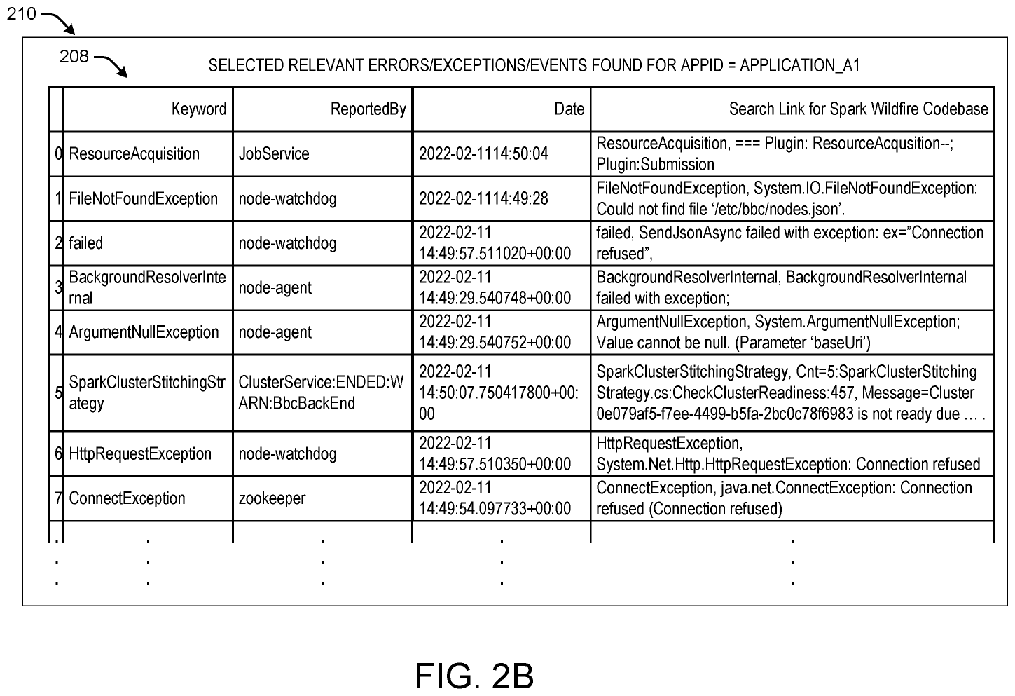

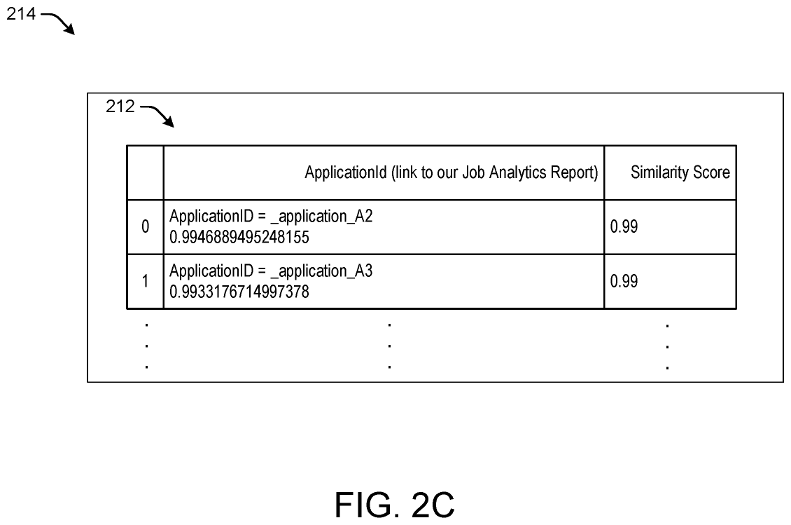

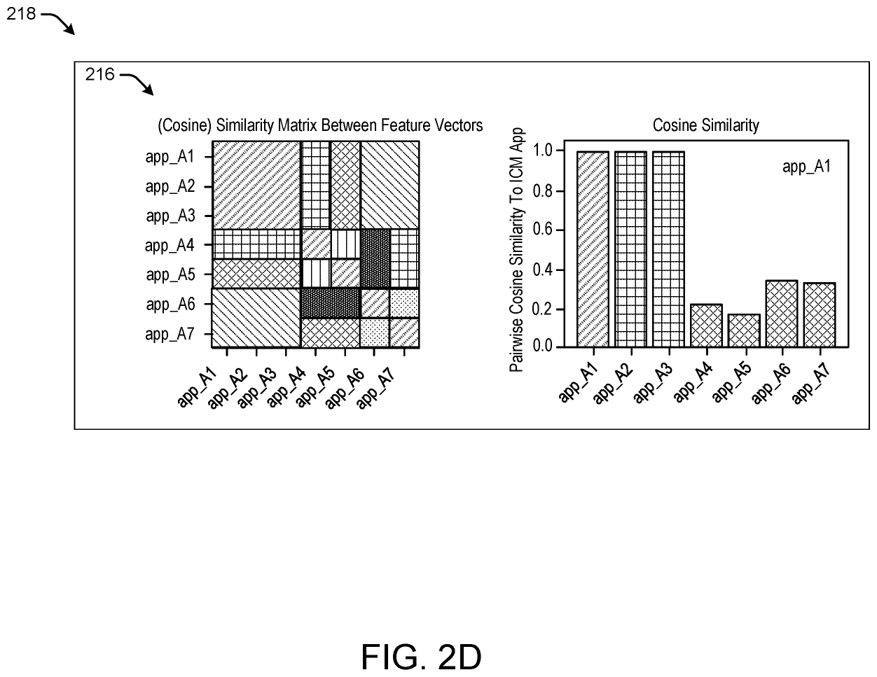

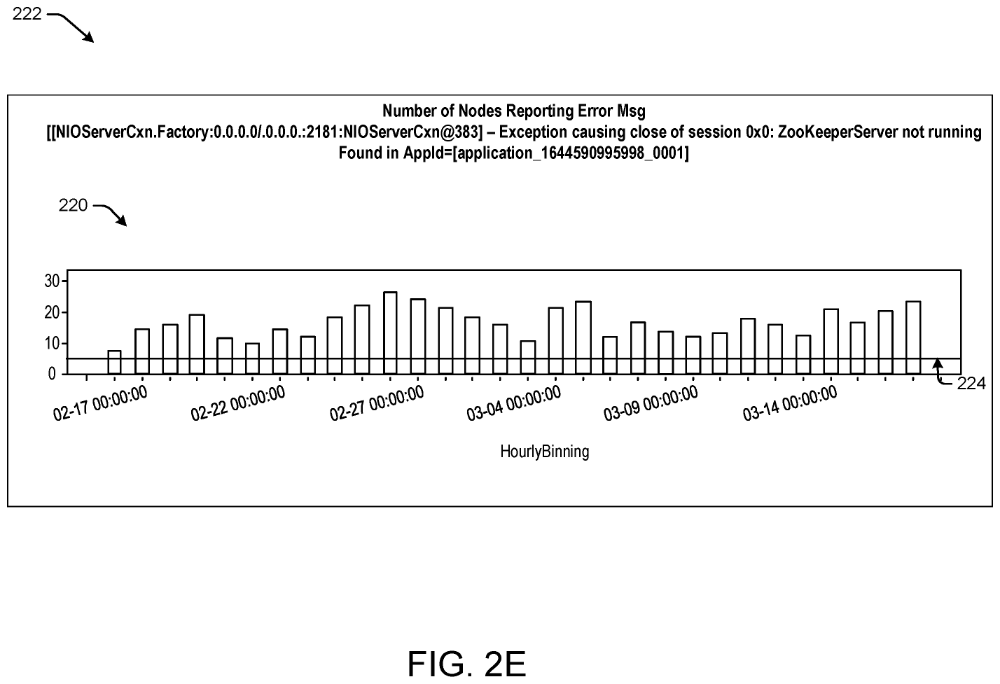

The visualization module 126 may generate visualization information (e.g., a GUI) 140 for presenting the log information 128(1)-(n), the signal information 130(1)-(n), the feature vectors 132(1)-(n), the anomaly information 134(1)-(n), the similarity information 136(1)-(n), and the inference information 136(1)-(n), and provide the visualization information 140 to the computing devices 108(1)-(n). In some aspects, the visualization module 126 may generate visualization information 140 displaying a summary of the lifecycle of the DDPE job in terms of the error, exception, and progress telemetry encountered within the workflow of the analytics service platform 102, as illustrated in FIG. 2A. In some aspects, the visualization module 126 may generate a visualization information 140 displaying a text summary of parsed key error, exception, and progress telemetry encountered within the workflow of the analytics service platform 102. Further, the errors and exceptions may be ordered with respect to real-time and link codebase references to the term. In some aspects, a virtual hard disk (VHD) may encapsulate the delivery of changes and fixes to a codebase. Further, the VHDs may be periodically released to incorporate bugfixes. In addition, in some aspects, the visualization module 126 may generate visualization information 140 displaying timelines of VHD changes to the workspace along with the module/package configurations. As such, the visualization information 140 may help to identify whether VHDs could have negatively impacted a DDPE job. In some aspects, the visualization module 126 may generate visualization information 140 displaying a similarity matrix, as illustrated in FIG. 2D. In some aspects, the visualization module 126 may generate visualization information 140 displaying fine-grained anomaly-based I/O data volume features of the execution of tasks within a particular stage to be used in featurization. In some aspects, the visualization module 126 may generate visualization information 140 displaying fine-grained anomaly-based timeline visualization summaries (e.g., summaries derived from time-based correlation over millions of telemetry records for this job) that identify the total ordering of events in the lifecycle of the related DDPE job. Further, in some examples, the errors and event source may be identified and labeled within the visualization information 140. In some aspects, the visualization module 126 may generate visualization information 140 displaying a fine-grained anomaly-based timeline visualization summaries that identify rhythmical and suspected straggler progression of tasks as well as suspect causation errors and anomalous performance metrics along with lifecycle events (e.g., beginning of a stage of DDPE job). Further, in some aspects, error conditions displayed within the timeline may be labeled to help investigate causation and identify consequences of the error conditions. In some aspects, the visualization module 126 may generate visualization information 140 in response to queries (e.g., SQL queries, domain assignment queries) received from the computing devices 108. Further, the visualization information 140 may display anomaly and summary data analytics along with comparative visualizations that show, for every uncovered error/exception of a particular DDPE job, the prevalence of the observed error across a random selection of other DDPE jobs running at the same time as particular DDPE job. In some aspects, the visualization module 126 may generate visualization information 140 displaying comparative error analysis. For example, the visualization information 140 may include a visual summary of distinct error behaviors in a plurality of visual plots Some examples of distinct error behaviors include errors within a workflow component, errors within a job, errors and outliers within a stage, errors within a given executor, comparative error density across random sample of clusters, comparative error density across time for some given error, etc.

FIG. 2A is a diagram illustrating an example timeline visualization summary (TVS) 200 presented within a GUI 202, in accordance with some aspects of the present disclosure. As illustrated in FIG. 2A, the GUI 202 generated by the visualization module 126 may include the TVS 200 identifying the ordering of events in the lifecycle of a DDPE job. As illustrated in FIG. 2A, the TVS 200 may further include lifecycle markers 204(1)-(n) identifying the beginning of the lifecycles of the DDPE job. Further, each lifecycle marker 204 may be displayed with one or more corresponding lifecycle events 206 that occurred during the lifecycle. In some aspects, graphical effects (e.g., different colors and/or fonts) may be applied to the individual lifecycle events to identify a source of an individual lifecycle event and/or a type of an individual lifecycle event. In some aspects, the GUI may display a summary of the lifecycle of the DDPE job in terms of the error, exception, and progress telemetry encountered within the workflow of the analytics service platform 102. Further, the GUI may highlight errors and exceptions along a real-time timeline wherein the events corresponding to the same lifecycle marker occur at approximately the same time. In some aspects, the TVS 200 provides a consistent signal extraction (causation analysis) platform for a large number of disparate potential error sources by means of key mapping error, warnings, progress, anomaly events into a consistent intermediary representation. Further, the ordering of the TVS enables a viewer to visually identify and zoom to errors that are the potential causes of a computation failure, whereas comparative ranking analysis only allows to a viewer to determine whether a log error message has unusual term importance. This is a reversal of standard debugging techniques, where the error pointed to, is typically the last and for which no context is provided as to its relative importance, density, or benignity.

FIG. 2B is a diagram illustrating an example text summary table (TST) 208 presented within a GUI 210, in accordance with some aspects of the present disclosure. As illustrated in FIG. 2B, the GUI 210 generated by the visualization module 126 may include the TST 208 presenting error telemetry, exception telemetry, and progress telemetry encountered during completion of an analytics workflow including performance of a DDPE job. In some aspects, error telemetry and exception telemetry may be ordered, and provide access to the corresponding codebase within the GUI 210 when selected.

FIG. 2C is a diagram illustrating an example similarity table (ST) 212 presented within a GUI 214, in accordance with some aspects of the present disclosure. As illustrated in FIG. 2C, the GUI 214 generated by the visualization module 126 may include the ST 212 presenting the similarity score between a particular DDPE jobs and one or more other DDPE jobs (e.g., historical DDPE jobs).

FIG. 2D is a diagram illustrating example similarity information 216 presented within a GUI 218, in accordance with some aspects of the present disclosure. As illustrated in FIG. 2D, the GUI 218 generated by the visualization module 126 may include similarity information 216 between a particular DDPE job and other DDPE.

FIG. 2E is a diagram illustrating example comparative error information 220 presented within a GUI, in accordance with some aspects of the present disclosure. For instance, the GUI 222 generated by the visualization module 126 may include a bar chart corresponding to a particular uncovered error condition, and the bar chart may illustrate the count per day of the error condition for a particular DDPE job. Further, the bar chart may include a threshold 224 indicating the average count of the error condition across a random sample of other DDPE jobs. In some aspects, the average count may be less than the levels observed across the random sample of other jobs running in the past 30 days. As such, the uncovered error condition may be a benign condition or an emerging service outage. In some other aspects, the count may be higher than that observed count across the random sample of other DDPE job, and diverge from a well-defined expectation with minimal variance. As such, the condition should be investigated and may require mitigation.

### Example Processes

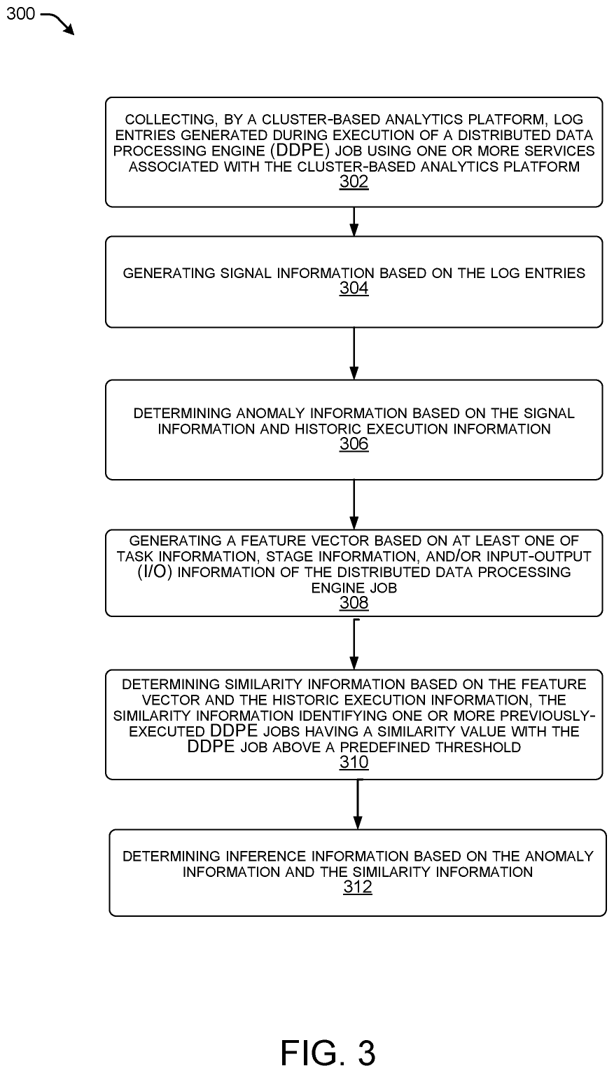

FIG. 3 is a flow diagram illustrating an example method 300 for implementing vendor-agnostic state and configuration collection from network devices, in accordance with some aspects of the present disclosure. The method 300 may be performed by one or more components of the analytics service platform 102, the computing device 400, or any device/component described herein according to the techniques described with reference to the previous figures.

At block 302, the method 300 may include collecting, by a cluster-based analytics platform, log entries generated during execution of a distributed data processing engine (DDPE) job using one or more services associated with the cluster-based analytics platform. For example, the logging module 114 may collect log information 128(1)-(n) from the DDPE instances 112(1)-(n) and the one or more services 106(1)-(n) generated during the execution of a particular DDPE job by the analytics service platform 102 via the DDPE instances 112(1)-(n).

Accordingly, the analytics service platform 102, the computing device 400, and/or the processor 402 executing the logging module 114 may provide means for collecting, by a cluster-based analytics platform, log entries generated during execution of a distributed data processing engine (DDPE) job using one or more services associated with the cluster-based analytics platform.

At block 304, the method 300 may include generating signal information based on the log entries. For example, the signal generation module 116 may generate the signal information 130(1)-(n) using the log information 128(1)-(n) generated during execution of the particular DDPE job. Further, in some aspects, the signal generation module 116(1)-(n) may employ machine learning and/or pattern recognition techniques to generate the signal information 130(1)-(n) from the log information 128(1)-(n).

Accordingly, the analytics service platform 102, the computing device 400, and/or the processor 402 executing the signal generation module 116 may provide means for generating signal information based on the log entries.

At block 306, the method 300 may include determining anomaly information based on the signal information and historic signal information. For example, the anomaly detection module 120 may determine the anomaly information 134(1)-(n) based on the signal information 130(1)-(n). In some aspects, the anomaly detection module 120 may compare the signal information 130 corresponding to the particular DDPE job to signal information 130 corresponding to previously-executed DDPE jobs. Further, in some aspects, the anomaly detection module 120 may employ machine learning and/or pattern recognition techniques to determine the anomaly information 134(1)-(n) from the signal information 130. For example, the similarity detection module 120 may employ a decision tree to determine the anomaly information 134(1)-(n).

Accordingly, the analytics service platform 102, the computing device 400, and/or the processor 402 executing anomaly detection module 120 may provide means for determining anomaly information based on the signal information and historic signal information.

At block 308, the method 300 may include generating a feature vector based on at least one of task information, stage information, and/or input-output (I/O) information of the distributed data processing engine job. For example, the featurization module 118 may generate a feature vector 132 for the particular DDPE job based on task information, stage information, and/or input-output (I/O) information associated with the DDPE job. For example, methods of featurization include but are not limited to frequency counts (of an error or warning), deviation from an expected value or tolerance, term and n-gram frequencies extracted from messages, text based similarity, indication of whether a message is an error, warning, etc., estimators of performance measurements for various aspects such as CPU, memory, disk, I/I, network, etc., estimators of stage and task performance measurements and progress completion, and progress indicators of workflow completion.

Accordingly, the analytics service platform 102, the computing device 400, and/or the processor 402 executing the featurization module 118 may provide means for generating a feature vector based on at least one of task information, stage information, and/or input-output (I/O) information of the distributed data processing engine job.

At block 310, the method 300 may include determining similarity information based on the feature vector and the historic signal information, the similarity information identifying one or more previously-executed DDPE jobs having a similarity value with the DDPE job above a predefined threshold. For example, the similarity detection module 122 may determine the similarity information 136(1)-(n) based upon the feature vectors 132(1)-(n). In some aspects, the similarity detection module 122 may employ at least one of a clustering distance technique, a cosine similarity technique, and/or a text-based similarity technique to determine similarity values between DDPE jobs using the feature vectors 132. In some aspects, the similarity information 136(1)-(n) is computing using mean value normalization, distance matrix computation, feature dimensionality reduction, and/or clustering. Similarity techniques tolerant to term transposition and reordering may be used over subsets of features such as SQL query similarity by text similarity measures. Similarly, stage and data reordering may be tolerated through cosine similarity and pairwise correlation measures.

Accordingly, the analytics service platform 102, the computing device 400, and/or the processor 402 executing the similarity detection module 122 may provide means for determining similarity information based on the feature vector and the historic signal information, the similarity information identifying one or more previously-executed DDPE jobs having a similarity value with the DDPE job above a predefined threshold.

At block 312, the method 300 may include determining inference information based on the anomaly information and the similarity information. For example, the analytics module 124 may generate the inference information 138(1)-(n) based upon the anomaly information 134(1)-(n) and the similarity information 136(1)-(n). In some aspects, the inference information 138(1)-(n) may include at least one of a likelihood of a predefined job result (e.g., success, failure, timeout), a mitigation strategy for resolving an error and/or exception, and/or a tuning strategy for improving execution of a job (e.g., reducing execution time, the number of errors/exceptions during execution, or the amount of resources consumed during execution). Further, the inference information 13(1)-(n) may be presented via a GUI.

Accordingly, the analytics service platform 102, the computing device 400, and/or the processor 402 executing the analytics module 124 may provide means for determining inference information based on the anomaly information and the similarity information.

In some aspects, the techniques described herein relate to a method, wherein determining the inference information comprises determining a likelihood of a predefined job result based on the anomaly information and the similarity information.

In some aspects, the techniques described herein relate to a method, wherein determining the inference information comprises determining a mitigation strategy for resolving an error and/or exception based on the anomaly information and the similarity information.

In some aspects, the techniques described herein relate to a method, wherein determining the inference information comprises determining a tuning strategy for based on the anomaly information and the similarity information, the tuning strategy predicted to improve execution of the DDPE job.

In some aspects, the techniques described herein relate to a method, further comprising generating a signal information graphical user interface (GUI), the signal information GUI displaying graphical indicia of at least one of scheduling of the DDPE job, execution of the DDPE job, teardown of a cluster associated with the DDPE job, or termination of the DDPE job, and the signal information GUI including a signal information entry with graphical indicia of a source of the signal information entry, date and time information of the signal information entry, and/or status information of the signal information entry.

In some aspects, the techniques described herein relate to a method, wherein the DDPE job is a first DDPE job, and further comprising generating a similarity information graphical user interface (GUI), the similarity GUI displaying graphical representation of a similarity value between the feature value and a feature value of a second DDPE job of the one or more previously-executed DDPE jobs.

In some aspects, the techniques described herein relate to a method, further comprising generating a similarity information graphical user interface (GUI), the similarity GUI displaying a graphical representation of a similarity value between the feature value and a feature value of a second DDPE job of the one or more previously-executed DDPE jobs.

In some aspects, the techniques described herein relate to a method, further comprising generating a comparative error information graphical user interface (GUI), the comparative error information GUI displaying a graphical representation of a comparison between an average count for a particular error for the first DDPE job and a plurality of other DDPE jobs.

While the operations are described as being implemented by one or more computing devices, in other examples various systems of computing devices may be employed. For instance, a system of multiple devices may be used to perform any of the operations noted above in conjunction with each other.

### Illustrative Computing Device

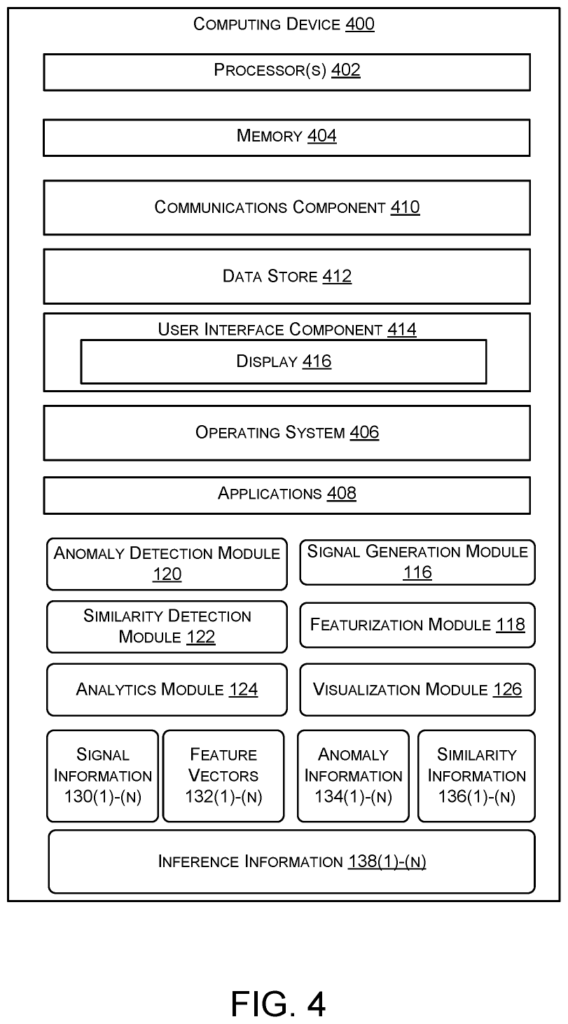

Referring now to FIG. 4, an example of a computing device(s) 400 (e.g., the analytics service platform 102). In one example, the computing device(s) 400 includes the processor 402 for carrying out processing functions associated with one or more of components and functions described herein. The processor 402 can include a single or multiple set of processors or multi-core processors. Moreover, the processor 402 may be implemented as an integrated processing system and/or a distributed processing system. In an example, the processor 402 includes, but is not limited to, any processor specially programmed as described herein, including a controller, microcontroller, a computer processing unit (CPU), a graphics processing unit (GPU), an application specific integrated circuit (ASIC), a field programmable gate array (FPGA), a system on chip (SoC), or other programmable logic or state machine. Further, the processor 402 may include other processing components such as one or more arithmetic logic units (ALUs), registers, or control units.

In an example, the computing device 400 also includes memory 404 for storing instructions executable by the processor 402 for carrying out the functions described herein. The memory 404 may be configured for storing data and/or computer-executable instructions defining and/or associated with the logging module 114, the signal generation module 116, the featurization module 118, the anomaly detection module 120, the similarity detection module 122, the analytics module 124, the visualization module 126, the signal information 130(1)-(n), the feature vectors 132(1)-(n), the anomaly information 134(1)-(n), the similarity information 136(1)-(n), inference information 138(1)-(n), and the visualization information 140, and the processor 402 may execute the logging module 114, the signal generation module 116, the featurization module 118, the anomaly detection module 120, the similarity detection module 122, the analytics module 124, and the visualization module 126. An example of memory 404 may include, but is not limited to, a type of memory usable by a computer, such as random access memory (RAM), read only memory (ROM), tapes, magnetic discs, optical discs, volatile memory, non-volatile memory, and any combination thereof. In an example, the memory 404 may store local versions of applications being executed by processor 402.

The example computing device 400 may include a communications component 410 that provides for establishing and maintaining communications with one or more other devices utilizing hardware, software, and services as described herein. The communications component 410 may carry communications between components on the computing device 400, as well as between the computing device 400 and external devices, such as devices located across a communications network and/or devices serially or locally connected to the computing device 400. For example, the communications component 410 may include one or more buses, and may further include transmit chain components and receive chain components associated with a transmitter and receiver, respectively, operable for interfacing with external devices.

The example computing device 400 may include a data store 412, which may be any suitable combination of hardware and/or software, that provides for mass storage of information, databases, and programs employed in connection with implementations described herein. For example, the data store 412 may be a data repository for the operating system 406 and/or the applications 408.

The example computing device 400 may include a user interface component 414 operable to receive inputs from a user of the computing device 400 and further operable to generate outputs for presentation to the user (e.g., a presentation of a GUI). The user interface component 414 may include one or more input devices, including but not limited to a keyboard, a number pad, a mouse, a touch-sensitive display (e.g., display 416), a digitizer, a navigation key, a function key, a microphone, a voice recognition component, any other mechanism capable of receiving an input from a user, or any combination thereof. Further, the user interface component 414 may include one or more output devices, including but not limited to a display (e.g., display 416), a speaker, a haptic feedback mechanism, a printer, any other mechanism capable of presenting an output to a user, or any combination thereof.

In an implementation, the user interface component 414 may transmit and/or receive messages corresponding to the operation of the operating system 406 and/or the applications 408. In addition, the processor 402 executes the operating system 406 and/or the applications 408, and the memory 404 or the data store 412 may store them.

Further, one or more of the subcomponents of the logging module 114, the signal generation module 116, the featurization module 118, the anomaly detection module 120, the similarity detection module 122, the analytics module 124, the visualization module 126, may be implemented in one or more of the processor 402, the applications 408, the operating system 406, and/or the user interface component 414 such that the subcomponents of the logging module 114, the signal generation module 116, the featurization module 118, the anomaly detection module 120, the similarity detection module 122, the analytics module 124, the visualization module 126 are spread out between the components/subcomponents of the computing device 400.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Non-transitory computer-readable media excludes transitory signals. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

### CONCLUSION

In closing, although the various embodiments have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method comprising:
collecting, by a cluster-based analytics platform, log entries generated during execution of a distributed data processing engine (DDPE) job using one or more services associated with the cluster-based analytics platform;
generating signal information based on the log entries;
determining anomaly information based on the signal information and historic signal information;
generating a feature vector based on at least one of task information, stage information, and/or input-output (I/O) information of the DDPE job;
determining similarity information based on the feature vector and the historic signal information, the similarity information identifying one or more previously-executed DDPE jobs having a similarity value with the DDPE job above a predefined threshold; and
determining inference information based on the anomaly information and the similarity information.

2. The method of claim 1, wherein determining the inference information comprises determining a likelihood of a predefined job result based on the anomaly information and the similarity information.

3. The method of claim 1, wherein determining the inference information comprises determining a mitigation strategy for resolving an error and/or exception based on the anomaly information and the similarity information.

4. The method of claim 1, wherein determining the inference information comprises determining a tuning strategy based on the anomaly information and the similarity information, the tuning strategy predicted to improve execution of the DDPE job.

5. The method of claim 1, further comprising generating a signal information graphical user interface (GUI), the signal information GUI displaying graphical indicia of at least one of scheduling of the DDPE job, execution of the DDPE job, teardown of a cluster associated with the DDPE job, or termination of the DDPE job, and the signal information GUI including a signal information entry with graphical indicia of a source of the signal information entry, date and time information of the signal information entry, and/or status information of the signal information entry.

6. The method of claim 1, further comprising generating an anomaly information graphical user interface (GUI), the anomaly information GUI displaying a signal information entry including an event and anomaly value of the event.

7. The method of claim 1, wherein the DDPE job is a first DDPE job, and further comprising generating a similarity information graphical user interface (GUI), the similarity information GUI displaying graphical representation of a similarity value between the feature value and a feature value of a second DDPE job of the one or more previously-executed DDPE jobs.

8. The method of claim 1, further comprising generating a comparative error information graphical user interface (GUI), the comparative error information GUI displaying a graphical representation of a comparison between an average count for a particular error for the DDPE job and an average count for the particular error for a plurality of other DDPE jobs.

9. The method of claim 1, wherein the one or more services include at least one of hypertext transport protocol (HTTP) frontend, a notebook, a credential service, a storage service, a database service, and a cluster service.

10. A non-transitory computer-readable device having instructions thereon that, when executed by at least one computing device, cause the at least one computing device to perform operations comprising:
collecting, by a cluster-based analytics platform, log entries generated during execution of a distributed data processing engine (DDPE) job using one or more services associated with the cluster-based analytics platform;
generating signal information based on the log entries;
determining anomaly information based on the signal information and historic signal information;
generating a feature vector based on at least one of task information, stage information, and/or input-output (I/O) information of the DDPE job;
determining similarity information based on the feature vector and the historic signal information, the similarity information identifying one or more previously-executed DDPE jobs having a similarity value with the DDPE job above a predefined threshold; and
determining inference information based on the anomaly information and the similarity information.

11. The non-transitory computer-readable device of claim 10, wherein determining the inference information comprises determining a likelihood of a predefined job result based on the anomaly information and the similarity information.

12. The non-transitory computer-readable device of claim 10, wherein determining the inference information comprises determining a mitigation strategy for resolving an error and/or exception based on the anomaly information and the similarity information.

13. The non-transitory computer-readable device of claim 10, wherein determining the inference information comprises determining a tuning strategy for based on the anomaly information and the similarity information, the tuning strategy predicted to improve execution of the DDPE job.

14. The non-transitory computer-readable device of claim 10, wherein the operations further comprise generating a signal information graphical user interface (GUI), the signal information GUI displaying graphical indicia of at least one of scheduling of the DDPE job, execution of the DDPE job, teardown of a cluster associated with the DDPE job, or termination of the DDPE job, and the signal information GUI including a signal information entry with graphical indicia of a source of the signal information entry, date and time information of the signal information entry, and/or status information of the signal information entry.

15. The non-transitory computer-readable device of claim 10, wherein the operations further comprise generating an anomaly information graphical user interface (GUI), the anomaly information GUI displaying a signal information entry including an event and anomaly value of the event.

16. The non-transitory computer-readable device of claim 10, wherein the DDPE job is a first DDPE job, and the operations further comprise generating a similarity information graphical user interface (GUI), the similarity GUI displaying graphical representation of a similarity value between the feature value and a feature value of a second DDPE job of the one or more previously-executed DDPE jobs.

17. A system comprising:
a memory storing instructions thereon; and
at least one processor coupled with the memory and configured by the instructions to:
collect, by a cluster-based analytics platform, log entries generated during execution of a distributed data processing engine (DDPE) job using one or more services associated with the cluster-based analytics platform;
generate signal information based on the log entries;
determine anomaly information based on the signal information and historic signal information;
generate a feature vector based on at least one of task information, stage information, and/or input-output (I/O) information of the distributed data processing engine job;
determine similarity information based on the feature vector and the historic signal information, the similarity information identifying one or more previously-executed DDPE jobs having a similarity value with the DDPE job above a predefined threshold; and
determine inference information based on the anomaly information and the similarity information.

18. The system of claim 17, wherein to determine the inference information, the at least one processor is configured by the instructions to determine a likelihood of a predefined job result based on the anomaly information and the similarity information.

19. The system of claim 17, wherein to determine the inference information, the at least one processor is configured by the instructions to determine a mitigation strategy for resolving an error and/or exception based on the anomaly information and the similarity information.

20. The system of claim 17, wherein to determine the inference information, the at least one processor is configured by the instructions to determine a tuning strategy for based on the anomaly information and the similarity information, the tuning strategy predicted to improve execution of the DDPE job.
